(19) United States
(12) Patent Application Publication
(10) Pub. No.: US 2013/0293918 A1
(43) Pub. Date: Nov. 7, 2013

(54) Fiscal Printer

(71) Applicants: Tamakazu Kitamura, Nagano-ken (JP); Hiroshi Yabe, Nagano-ken (JP)

(72) Inventors: Tamakazu Kitamura, Nagano-ken (JP); Hiroshi Yabe, Nagano-ken (JP)

(73) Assignee: SEIKO EPSON CORPORATION, Tokyo (JP)

(21) Appl. No.: 13/821,107

(22) PCT Filed: Oct. 14, 2011
(86) PCT No.: PCT/JP2011/074241

§ 371 Date: Mar. 6, 2013

(30) Foreign Application Priority Data
Nov. 11, 2010 (JP) 2010-252562
Apr. 12, 2011 (JP) 2011-087993

(51) Int. Cl. G06K 15/00

(52) U.S. Cl. CPC G06K 15/4095
USPC 358/1.14

(57) ABSTRACT

Tampering with fiscal information written to memory can be detected without reducing the write speed. When fiscal information is written to first memory unit 411 by means of a fiscal control CPU 42 , a memory control CPU 412 writes a first hash value corresponding to the fiscal information in second memory unit 413. When fiscal information is read from the first memory unit 411, the fiscal control CPU 42 reads the first hash value from the second memory unit 413 through the memory control CPU 412, compares the first hash value with a second hash value calculated from the fiscal information read from first memory unit 411, and detects tampering with the fiscal information.

### TECHNICAL FIELD

The present invention relates to a fiscal printer with a function for printing receipts and storing and saving fiscal information related to sales transactions in fiscal memory.

This application is based upon Japan Patent Appl. Pub. No. 2010-252562 filed on Nov. 11, 2010, and Japan Patent Appl. Pub. No. 2011-087993 filed on Apr. 21, 2011, the entire contents of which are incorporated by reference herein.

### BACKGROUND ART

Fiscal printers are used as cash register printers in POS systems, for example, and have functions for printing receipts, and storing and saving transaction information (fiscal information) such as sale and tax information related to product sales transactions. The fiscal printer described in Patent Reference 1 has fiscal memory for storing fiscal information.

The fiscal information that must be stored by a fiscal printer is determined by local laws, and the fiscal information stored in fiscal memory may be used in tax audits, for example. OTP-ROM (One Time Programmable Read Only Memory) is therefore used as fiscal memory to ensure that fiscal information that has been written cannot be deleted or over-written.

OTP-ROM has become hard to find due to decreased demand in recent years, and it would therefore be quite beneficial for product manufacturing if rewritable nonvolatile memory could be used as a replacement for OTP-ROM. However, if rewritable nonvolatile memory is used for fiscal memory, the fiscal information stored in fiscal memory can be easily deleted, changed, and otherwise tampered with. Some means of preventing tampering, such as a device that prevents tampering or some way of detecting tampering when it occurs, is therefore needed.

Technologies for preventing tampering with information include encrypting information using an encryption key such as taught in Patent Reference 2.

### CITATION LIST

### Patent Literature

Patent Reference 1: Japanese Unexamined Patent Appl. Pub. JP-A-2008-276593

Patent Reference 2: Japanese Unexamined Patent Appl. Pub. JP-A-2003-69551

### SUMMARY OF INVENTION

### Technical Problem

However, a problem with technologies that prevent tampering by encrypting the fiscal information is that tampering cannot be prevented if the encryption key is used illicitly. Because it is also not possible to detect tampering when tampering occurs by illicit use of the encryption key, fiscal information that has been tampered with may be used as tax data for auditing purposes. Another problem is that writing fiscal information to fiscal memory becomes slower because the load on the control unit of the fiscal printer is increased when encrypting the fiscal information.

Reducing tampering by making it possible to detect tampering when tampering occurs is conceivable, but a fiscal printer that can detect if there has been any tampering with fiscal information written to rewritable nonvolatile memory without reducing the write speed to nonvolatile memory has not been proposed.

With consideration for this problem, an object of the present invention is to provide a fiscal printer that can detect if there has been any tampering with fiscal information written to rewritable nonvolatile memory without reducing the write speed to nonvolatile memory.

### Solution to Problem

### EMBODIMENT 1

To achieve the foregoing object, a fiscal printer according to the invention is characterized by having: a nonvolatile first memory unit in which fiscal information is written and read; a second memory unit in which a first hash value, which is calculated for the fiscal information using a specific hash function, is written and read when the fiscal information is written to the first memory unit ; and a tampering detection unit that, when the fiscal information is read from the first memory unit, determines if the fiscal information read from the first memory unit was tampered with based on the first hash value read from the second memory unit, and a second hash value that is calculated using the hash function for the fiscal information read from the first memory unit.

### EMBODIMENT 2

A fiscal printer according to another aspect of the invention is characterized by also having: a fiscal memory module for storing the fiscal information; and a control unit that writes and reads the fiscal information in the fiscal memory module ; wherein the fiscal memory module includes the first memory unit in which the fiscal information is written and read by the control unit, a memory control unit that monitors writing to the first memory unit by the control unit, and a nonvolatile second memory unit that is written and read by the memory control unit; the memory control unit calculates a first hash value corresponding to the fiscal information using a specific hash function and writes the first hash value to the second memory unit when the fiscal information is written to the first memory unit; and the control unit includes a hash value acquisition unit that reads the first hash value from the second memory unit through the memory control unit when reading the fiscal information from the first memory unit, a hash value calculation unit that uses the hash function to calculate a second hash value corresponding to the fiscal information read from the first memory unit, and a tampering detection unit that determines based on the second hash value and first hash value if the fiscal information read from the first memory unit was tampered with.

When the fiscal information has not been tampered with, the first hash value that is written to the second memory unit by the memory control unit when information is written to the first memory unit, and the second hash value that the control unit calculates from the fiscal information read from the first memory unit, will be the same values. Whether or not the fiscal information stored in the first memory unit has been tampered with can therefore be determined by comparing the first hash value and second hash value. Using fiscal information that has been tampered with for a tax audit, for example, can therefore be prevented. In addition, the write speed to the first memory unit does not drop because the control unit does not need to encrypt the fiscal information and can write directly to the first memory unit.

### EMBODIMENT 3

In another aspect of the invention, the memory control unit calculating a hash value based on all fiscal information written in the first memory unit, and writing the calculated hash value as the first hash value to the second memory unit; the hash value acquisition unit acquiring the first hash value from the second memory unit through the memory control unit; and the hash value calculation unit calculating the second hash value based on all fiscal information read from the first memory unit.

This aspect of the invention enables simplifying the hash value calculation process because the hash value is always calculated based on all fiscal information, and enables using a memory device with extremely small storage capacity as the second memory unit because only one first hash value is always stored. The memory control unit can also calculate the first hash value and write the first hash value to the second memory unit parallel to the control unit writing fiscal information to the first memory unit. The write speed to nonvolatile memory therefore does not drop.

### EMBODIMENT 4

In another aspect of the invention, the memory control unit calculates one hash value for each unit in which fiscal information is appended to the first memory unit based on at least two units of information including the appended unit of fiscal information and the first hash value already written to the second memory unit, and writes the calculated hash value as the new first hash value in the second memory unit; the hash value acquisition unit acquires the new first hash value from the second memory unit through the memory control unit; and the hash value calculation unit calculates one hash value based on at least two units of information including the one unit of fiscal information and the already calculated second hash value each time the one unit of appended fiscal information is read from the first memory unit, and uses the calculated hash value as the new second hash value.

Compared with calculating the hash value based on all fiscal information, this aspect of the invention enables the memory control unit to use less data when calculating the hash value, and reduces the processor load associated with calculating the hash value. In addition, the memory control unit can calculate the first hash value and write the first hash value to the second memory unit parallel to the control unit writing fiscal information to the first memory unit . The data write speed to nonvolatile memory therefore does not drop.

### EMBODIMENT 5

In another aspect of the invention, the memory control unit prohibits erasing and overwriting the second memory unit.

Overwriting the first hash value can thus be avoided.

### EMBODIMENT 6

In another aspect of the invention, the first memory unit is divided into a plurality of memory areas; the memory control unit calculates a hash value for each memory area based on the information written to the particular memory area, and writes the calculated hash value as the first hash value correlated to the particular memory area in the second memory unit; the hash value acquisition unit acquires the first hash value correlated to the memory area from which information is read; and the hash value calculation unit calculates for each memory area a second hash value corresponding to the information read from the memory area.

Compared with a configuration that calculates the hash value for all fiscal information, this aspect of the invention disperses the load on the memory control unit when calculating the first hash value. The memory control unit can also calculate the first hash value and write the first hash value to the second memory unit parallel to the control unit writing fiscal information to the first memory unit. The data write speed to nonvolatile memory therefore does not drop.

### EMBODIMENT 7

Further preferably in another aspect of the invention, the fiscal memory module has a circuit board including the first memory unit, the memory control unit, and the second memory unit; and at least the memory control unit, the second memory unit, and wiring electrically connecting the memory control unit and second memory unit are sealed in resin.

This aspect of the invention avoids the first hash value written to the second memory unit being overwritten by directly accessing the second memory unit from the outside.

### EMBODIMENT 8

Yet further preferably in another aspect of the invention, the first memory unit is rewritable nonvolatile memory.

This aspect of the invention enables using widely distributed devices such as flash memory for the fiscal memory module.

### BRIEF DESCRIPTION OF THE DRAWINGS

FIG. 1 is a block diagram showing the main parts of the control system of a fiscal printer.

FIG. 2 describes memory areas in first and second memory devices in a first embodiment and a second embodiment of the invention.

FIG. 3 describes memory areas in first and second memory devices in a third embodiment of the invention.

### DESCRIPTION OF EMBODIMENTS

A preferred embodiment of a fiscal printer according to the invention is described below with reference to the accompanying figures.

### Configuration of a Fiscal Printer

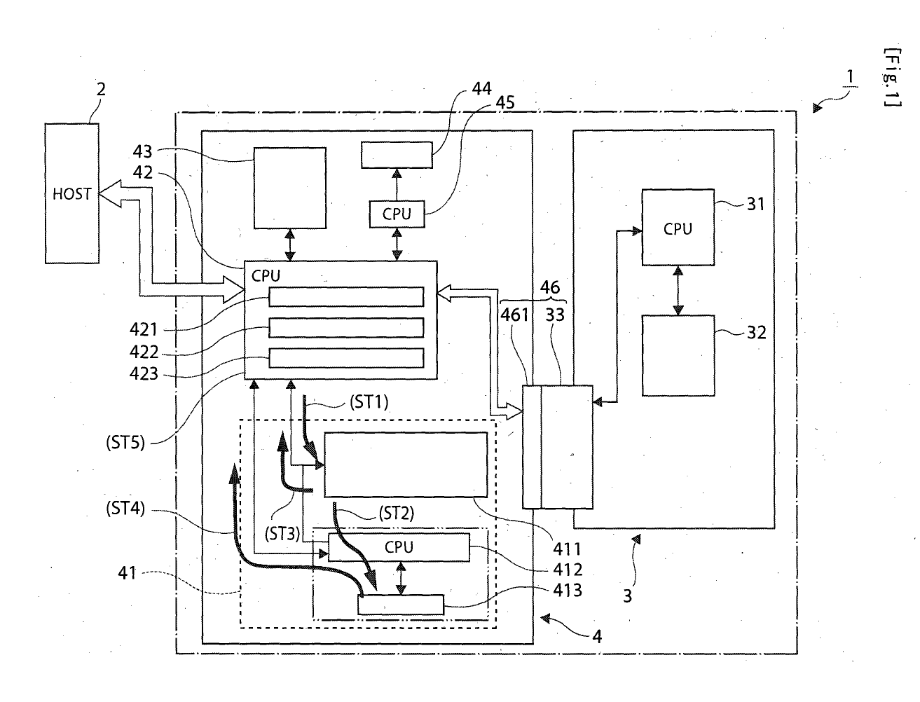

The configuration of a fiscal printer is shown in FIG. 1. FIG. 1 is a block diagram showing the main parts of the control system of a fiscal printer according to this embodiment of the invention. The fiscal printer 1 is used connected to the host computer 2 of the POS system, and prints print data related to sales information supplied from the computer 2 side as receipts. The fiscal printer 1 also has a function that saves the fiscal information related to the sale transaction supplied from the computer 2 side each time a transaction is processed.

As shown in FIG. 1, the fiscal printer 1 has a printer control board 3 and a fiscal control board 4. A printer control CPU 31 with a printer control function identical to that of a general printer, and flash memory 32, which is a type of rewritable nonvolatile memory, for storing printer control firmware, are mounted on the printer control board 3 for printing operations.

A fiscal memory module 41 for storing fiscal information, and a fiscal control CPU 42 (control unit) that writes and reads fiscal information in fiscal memory module 41, are mounted on the fiscal control board 4. RAM 43 that is used for operations by the fiscal control CPU 42 is connected to the fiscal control CPU 42.

The fiscal memory module 41 includes a first memory unit 411 to which fiscal information is written by the fiscal control CPU 42, a memory control CPU 412 (memory control unit) that monitors 42 writing to the first memory unit 411 by the fiscal control CPU 42, and a second memory unit 413 that is written and read by the memory control CPU 412.

The first memory unit 411 and second memory unit 413 are rewritable nonvolatile memory devices such as flash memory devices. As described below, the storage capacity of the second memory unit 413 may be less than the first memory unit 411. When fiscal information is written to the first memory unit 411 by the fiscal control CPU 42, the memory control CPU 412 calculates and writes a first hash value corresponding to the fiscal information to the second memory unit 413.

The memory control CPU 412, the second memory unit 413, and the lines electrically connecting the memory control CPU 412 and second memory unit 413 are sealed in epoxy resin, for example, on the fiscal control board 4 as indicated by the double-dot dash line in FIG. 1. By thus sealing these devices, overwriting the first hash value written to the second memory unit 413 by directly accessing the second memory unit 413 from the outside is prevented.

The fiscal control CPU 42 has an interface function for communicating information with the host computer 2, and an interface function for communicating information with the printer control CPU 31. The fiscal control CPU 42 also has a hash acquisition unit 421 that gets the first hash value from the second memory unit 413 through the memory control CPU 412 when fiscal information is read from the first memory unit 411. A hash calculator 422 calculates a second hash value for the fiscal information read from the first memory unit 411. A tampering detection unit 423 then determines if there was any tampering with the fiscal information read from the first memory unit 411 based on the second hash value and the first hash value.

EJ (Electronic Journal) memory 44 for storing receipt content and an EJ memory control CPU 45 are mounted on the fiscal control board 4. The EJ memory control CPU 45 communicates with the fiscal control CPU 42, receives text information related to the receipt content each time a receipt is issued by the fiscal printer 1, and stores the text information in the EJ memory 44.

The fiscal control board 4 is installed so that it can be removed from the printer, and is electrically connected to the printer control board 3 through a disconnectable connector 46. The connector 46 has a printer-side connector 33 disposed to the printer control board 3, and a fiscal-side connector 461 disposed to the fiscal control board 4, and these connectors are disconnectably connected. Someone with the proper authority can therefore remove the fiscal control board 4 from the fiscal printer 1 and acquire the data stored in the fiscal memory module 41 mounted thereon.

### Writing and Reading Fiscal Information

### EMBODIMENT 1

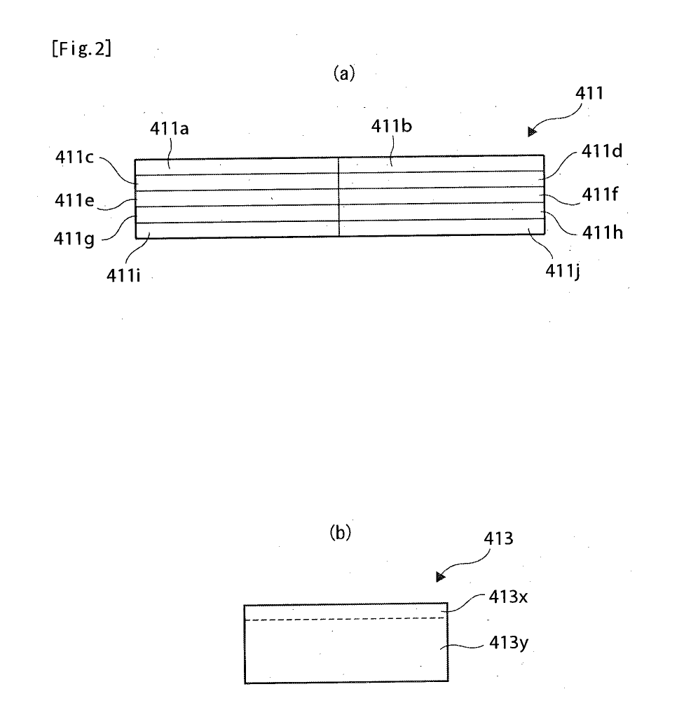

Writing and reading fiscal information in the first embodiment of the invention is described next with reference to FIG. 2. FIG. 2 describes memory areas in the first and second memory units in the first and second embodiments. More specifically, FIG. 2 (a) shows memory areas in the first memory unit, and FIG. 2 (b) describes memory areas in the second memory unit . When the fiscal control CPU 42 writes fiscal information to the first memory unit 411 of the fiscal memory module 41 (step ST1) , the memory control CPU 412 that monitors writing calculates a first hash value based on all fiscal information written to the first memory unit 411, and writes to the second memory unit 413 (step ST2).

More specifically, the fiscal control CPU 42 writes fiscal information sequentially to memory areas 411a, 411b, . . . in the first memory unit 411 as shown in FIG. 2 (a). When fiscal information is written to the first memory unit 411 by the fiscal control CPU 42, the memory control CPU 412 calculates the first hash value based on all of the fiscal information written to first memory unit 411, and writes the hash value to the second memory unit 413. Note that the memory areas 411a, 411b, . . . of the first memory unit 411 may be fixed-length or vary according to the amount of sequentially written fiscal information.

This embodiment uses SHA-1 as the hash function, and the first hash value based on all fiscal information that is calculated by the memory control CPU 412 has a fixed length of 20 bytes. Because the second memory unit 413 therefore only requires a mere 20 bytes, an extremely small capacity memory device can be used for the second memory unit 413.

Because the memory control CPU 412 always only needs to calculate the first hash value based on the total fiscal information written to memory areas 411a, 411b, . . . , the process that calculates the first hash value can be simplified. In addition, the memory control CPU 412 can calculate the first hash value and write the first hash value to second memory unit 413 parallel to the fiscal control CPU 42 writing fiscal information to the first memory unit 411. Furthermore, because this embodiment of the invention can detect tampering with the fiscal information as described below, the fiscal control CPU 42 can write directly to the first memory unit 411 without needing to encrypt the fiscal information. The fiscal information write speed of the fiscal control CPU 42 to the first memory unit 411 therefore does not drop.

When the fiscal control CPU 42 reads the fiscal information stored in the first memory unit 411 (step ST3), the hash acquisition unit 421 acquires the first hash value from the second memory unit 413 by means of the memory control CPU 412 (step ST4). The hash calculator 422 also calculates the second hash value based on the total fiscal information stored in first memory unit 411. The hash calculator 422 calculates the second hash value using the same hash function as the hash function used to calculate the first hash value. The tampering detection unit 423 then compares the first hash value and the second hash value to determine if the fiscal information read from the first memory unit 411 has been tampered with (step ST5).

More specifically, when there has been no tampering with the fiscal information, the first hash value written by the memory control CPU 412 to the second memory unit 413 when writing to first memory unit 411, and the second hash value calculated by the fiscal control CPU 42 from the fiscal information read from first memory unit 411, will be the same. If the fiscal information has been tampered with, however, the first hash value and second hash value will differ. Tampering with fiscal information stored in the first memory unit 411 can therefore be detected based on the first hash value and second hash value. Using fiscal information that has been tampered with for tax audits can therefore be prevented.

### EMBODIMENT 2

Writing and reading fiscal information in a second embodiment of the invention is described next with reference to the same FIG. 2. Note that like parts in this and the first embodiment are identified by like reference numerals, and repeated description thereof is omitted below.

The operation whereby the fiscal control CPU 42 writes fiscal information to the first memory unit 411 of the fiscal memory module 41 (step ST1) is the same as in the first embodiment described above. The memory control CPU 412 that monitors this writing operation calculates a single hash value based on at least two units of information including a single unit of appended fiscal information (the fiscal information written to any one of memory areas 411a, 411b, . . . ) and the first hash value already written to the second memory unit 413. The calculated hash value is then written as the first hash value to the second memory unit 413 (step ST2).

More specifically, the first memory unit 411 sequentially writes fiscal information to the memory areas 411a, 411b, . . . and so forth by means of the fiscal control CPU 42 as shown in FIG. 2 (a). When the fiscal control CPU 42 writes new fiscal information to the first memory unit 411, the memory control CPU 412 reads the first hash value currently stored in the second memory unit 413, and calculates a hash value based on this first hash value and the new fiscal information written to the first memory unit 411. This calculated hash value is then written as the new first hash value to second memory unit 413.

The memory areas 411a, 411b, . . . of the first memory unit 411 may be fixed-length storage areas or variable according to the amount of sequentially written fiscal information. In addition, the second memory unit 413 may be divided into two memory areas (413x, 413y) as shown in FIG. 2 (b) with one area used as the storage area for the newest first hash value and the other area used as operating memory for the memory control CPU 412 to calculate the newest first hash value. Memory used for operating processes could alternatively use memory internal to the memory control CPU 412 instead of using the second memory unit 413.

If this embodiment of the invention also uses SHA-1 as the hash function, the newest first hash value will be a fixed-length 20 byte value, and a small capacity device can be used for the second memory unit 413.

Because the memory control CPU 412 calculates a new first hash value based on the new fiscal information written to one memory area 411a, 411b, . . . , and the current first hash value written to the second memory unit 413, the load on the memory control CPU 412 can be reduced because less information is processed than when the hash value is calculated based on all of the fiscal information. As in the first embodiment, calculating the first hash value and writing the first hash value to second memory unit 413 by means of the memory control CPU 412 can also proceed parallel to the fiscal control CPU 42 writing fiscal information to the first memory unit 411. Furthermore, as in the first embodiment, the fiscal control CPU 42 can write directly to the first memory unit 411 without needing to encrypt the fiscal information. The fiscal information write speed of the fiscal control CPU 42 to the first memory unit 411 therefore does not drop.

When the fiscal control CPU 42 then reads the fiscal information stored in the first memory unit 411 (step ST3), the hash acquisition unit 421 gets the first hash value from the second memory unit 413 through the memory control CPU 412 (step ST4). The hash calculator 422 also reads the fiscal information that was written first from the memory areas 411a, 411b, . . . of the first memory unit 411, and calculates the second hash value . The hash calculator 422 then repeats sequentially reading the fiscal information in the order written, and calculating a new second hash value based on both the previously calculated second hash value and the newly read fiscal information, until all fiscal information stored in the first memory unit 411 has been read. The tampering detection unit 423 then compares the first hash value and second hash value, and determines if the fiscal information read from the first memory unit 411 was tampered with (step ST5).

More specifically, when the fiscal information has not been tampered with, the first hash value written to the second memory unit 413 by the memory control CPU 412 when writing to the first memory unit 411, and the second hash value calculated by the fiscal control CPU 42 from the fiscal information read from the first memory unit 411, will be the same. If the fiscal information has been tampered with, the first hash value and second hash value will differ. Whether or not the fiscal information stored in the first memory unit 411 has been tampered with can thus be determined based on the first hash value and second hash value. Use of fiscal information that has been tampered with in a tax audit, for example, can therefore be prevented.

### EMBODIMENT 3

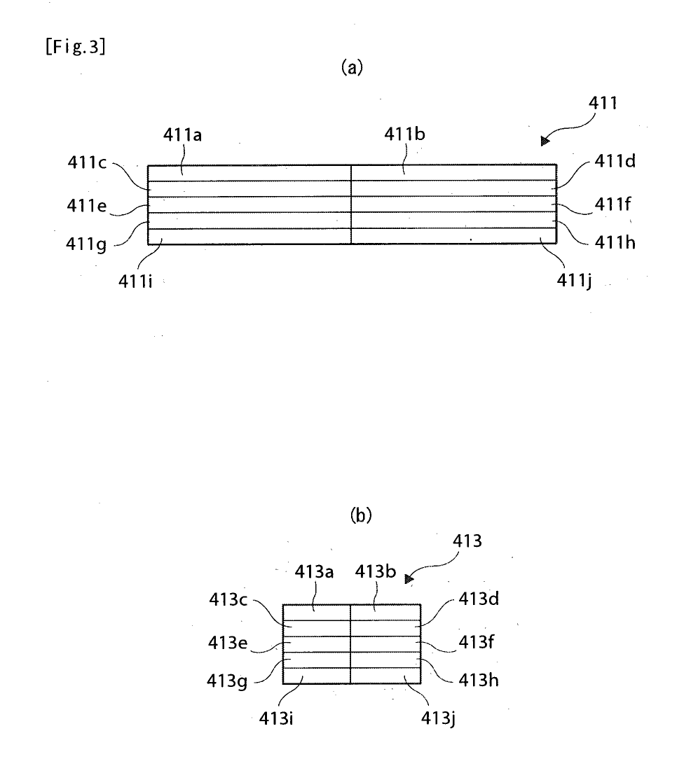

Writing and reading fiscal information by means of a third embodiment of the invention is described next with reference to FIG. 3. FIG. 3 describes memory areas in first and second memory devices according to a third embodiment of the invention. Note that like parts in this and the first and second embodiments of the invention are identified by like reference numerals, and repetitive description thereof is omitted below.

When the fiscal control CPU 42 writes fiscal information to the first memory unit 411 of the fiscal memory module 41 (step ST1), the memory control CPU 412 that monitors writing fiscal information calculates a first hash value for the fiscal information that is written, and writes the first hash value to the second memory unit 413 (step ST2).

More specifically, the first memory unit 411 is segmented into a plurality of memory areas as shown in FIG. 3 (a), the memory control CPU 412 calculates a first hash value for each memory area 411a, 411b, . . . based on the fiscal information written to the memory area 411a, 411b, . . . , and writes the hash value linked to the related memory area 411a, 411b, . . . in the second memory unit 413.

This embodiment of the invention uses SHA-1 as the hash function, and the first hash values calculated for the information in each memory area 411a, 411b, . . . by the memory control CPU 412 are 20-byte fixed-length values. The first hash values calculated for the information in each memory area 411a, 411b, . . . in the first memory unit 411 are written to memory areas 413a, 413b, . . . in the second memory unit 413, which are made to correspond to the memory areas 411a, 411b, . . . in the first memory unit 411, and are thereby correlated to the memory areas 411a, 411b, ... in the first memory unit 411. The capacity of the second memory unit 413 can therefore be determined according to the capacity of the first memory unit 411, and nonvolatile memory with the minimum required capacity can be used as the second memory unit 413.

Because the memory control CPU 412 calculates a first hash value for each memory area 411a, 411b, . . . based on the information written to the individual memory area 411a, 411b, . . . , the load on the fiscal control CPU 42 is reduced compared with a configuration that calculates a hash value for all of the fiscal information. In addition, calculating the second hash value and writing to the second memory unit 413 by means of the memory control CPU 412 can proceed parallel to writing fiscal information to the first memory unit 411 by means of the fiscal control CPU 42. In addition, the fiscal control CPU 42 does not need to encrypt the fiscal information, and can write directly to the first memory unit 411. The fiscal information write speed of the fiscal control CPU 42 to the first memory unit 411 therefore does not drop.

When the fiscal control CPU 42 reads fiscal information from the first memory unit 411 (step ST3), the hash acquisition unit 421 acquires the first hash value corresponding to the memory area 411a, 411b, . . . of the first memory unit 411 from which the fiscal information was read by means of the memory control CPU 412 from the second memory unit 413 (step ST4). Based on the information read from the memory area 411a, 411b, . . . , the hash calculator 422 then calculates a second hash value for each memory area 411a, 411b, . . . in the first memory unit 411. At this time the hash calculator 422 calculates the second hash value using the same hash function as the hash function used to calculate the first hash value. Based on the first hash value and second hash value, the tampering detection unit 423 then determines whether or not the fiscal information read from the first memory unit 411 was tampered with (step ST5).

More specifically, if the fiscal information has not been tampered with, the first hash value written by the memory control CPU 412 to the second memory unit 413 when writing to the first memory unit 411, and the second hash value calculated by the fiscal control CPU 42 from the fiscal information read from the first memory unit 411, will be the same. However, if the fiscal information has been tampered with, the first hash value and second hash value will differ. Therefore, whether or not the fiscal information stored in the first memory unit 411 has been tampered with can be determined based on the first hash value and second hash value. Using fiscal information that has been tampered with for a tax audit can therefore be prevented.

### OTHER EMBODIMENTS

The invention is not limited to the embodiment described above, and can be modified and improved in many ways. Examples of other such configurations are described below.

In the embodiment described above the first memory unit 411 and second memory unit 413 are both flash memory or other rewritable nonvolatile memory devices, but OTP-ROM or other non-rewritable nonvolatile memory device may be used for the small capacity second memory unit 413. This can more reliably prevent the first hash values written to the second memory unit 413 from being externally accessed and tampered with.

In addition, in order to determine on the fiscal memory module 41 side whether the fiscal control CPU 42 has permission to read and write the fiscal memory module 41, the fiscal control CPU 42 could add a digital signature to the fiscal information written to the fiscal memory module 41. In this case, the memory control CPU 412 may verify based on the digital signature if the fiscal control CPU 42 has read/write permission.

1. A fiscal printer comprising:
a nonvolatile first memory unit in which fiscal information is written and read;
a second memory unit in which a first hash value, which is calculated for the fiscal information using a specific hash function, is written and read when the fiscal information is written to the first memory unit; and
a tampering detection unit that, when the fiscal information is read from the first memory unit, determines if the fiscal information read from the first memory unit was tampered with based on the first hash value read from the second memory unit, and a second hash value that is calculated using the hash function for the fiscal information read from the first memory unit.

2. The fiscal printer described in claim 1, further comprising:
a fiscal memory module for storing the fiscal information; and
a control unit that writes and reads the fiscal information in the fiscal memory module;
wherein the fiscal memory module includes
the first memory unit in which the fiscal information is written and read by the control unit,
a memory control unit that monitors writing to the first memory unit by the control unit, and
a nonvolatile second memory unit that has less capacity than the first memory unit and which is written and read by the memory control unit;
the memory control unit calculates a first hash value corresponding to the fiscal information using a specific hash function and writes the first hash value to the second memory unit when the fiscal information is written to the first memory unit; and
the control unit includes
a hash value acquisition unit that reads the first hash value from the second memory unit through the memory control unit when reading the fiscal information from the first memory unit,
a hash value calculation unit that uses the hash function to calculate a second hash value corresponding to the fiscal information read from the first memory unit, and
a tampering detection unit that determines based on the second hash value and first hash value if the fiscal information read from the first memory unit was tampered with.

3. The fiscal printer described in claim 2, wherein:
the memory control unit calculates a hash value based on all fiscal information written in the first memory unit, and writes the calculated hash value as the first hash value to the second memory unit;
the hash value acquisition unit acquires the first hash value from the second memory unit through the memory control unit; and
the hash value calculation unit calculates the second hash value based on all fiscal information read from the first memory unit.

4. The fiscal printer described in claim 2, wherein:
the memory control unit calculates one hash value for each unit in which fiscal information is appended to the first memory unit based on at least two units of information including the appended unit of fiscal information and the first hash value already written to the second memory unit, and writes the calculated hash value as the new first hash value in the second memory unit;
the hash value acquisition unit acquires the new first hash value from the second memory unit through the memory control unit; and
the hash value calculation unit calculates one hash value based on at least two units of information including the one unit of fiscal information and the already calculated second hash value each time the one unit of appended fiscal information is read from the first memory unit, and uses the calculated hash value as the new second hash value.

5. The fiscal printer described in claim 2,
the memory control unit prohibits erasing and overwriting the second memory unit.

6. The fiscal printer described in claim 2 wherein:
the first memory unit is divided into a plurality of memory areas;
the memory control unit calculates a hash value for each memory area based on the information written to the particular memory area, and writes the calculated hash value as the first hash value correlated to the particular memory area in the second memory unit;
the hash value acquisition unit acquires the first hash value correlated to the memory area from which information is read; and
the hash value calculation unit calculates for each memory area a second hash value corresponding to the information read from the memory area.

7. The fiscal printer described in claim 2, wherein:
the fiscal memory module has a circuit board including the first memory unit, the memory control unit, and the second memory unit; and
at least the memory control unit, the second memory unit, and wiring electrically connect the memory control unit and second memory unit being sealed in resin.

8. The fiscal printer described in claim 1, wherein:
the first memory unit comprises a rewritable nonvolatile memory.
